(19) United States
(12) Patent Application Publication
(10) Pub. No.: US 2020/0209110 A1
(43) Pub. Date: Jul. 2, 2020

(54) TIRE INSPECTION APPARATUS

(71) Applicant: Toyo Tire Corporation, Itami-shi (JP)

(72) Inventor: Shuhei Ito, Itami-shi (JP)

(73) Assignee: Toyo Tire Corporation, Itami-shi (JP)

(21) Appl. No.: 16/702,803

(22) Filed: Dec. 4, 2019

(30) Foreign Application Priority Data
Dec. 26, 2018 (JP) 2018-243179

(51) Int. Cl. G01M 17/02; G01N 22/02

(52) U.S. Cl. CPC G01M 17/021; G01N 22/02

(57) ABSTRACT

A tire inspection apparatus of the exemplary embodiment includes a conveyor 5 configured to convey a vulcanized tire T; a centering device 52 configured to position the tire T conveyed by the conveyor 5 to a predetermined position; an inspection part 54 provided on a side of the conveyor 5 and configured to inspect an internal defect of the tire T, and a conveying device 56 configured to convey the tire T positioned by the centering device 52 to the inspection part 54 with holding the tire T, wherein the conveying device 56 includes a chuck driving means 65 for rotating the tire T around an axis of the tire with holding the tire, and wherein the inspection part 54 is configured to inspect an internal defect of the tire T held by the conveying device 56.

### TECHNICAL FIELD

The present invention relates to a tire inspection apparatus.

### BACKGROUND ART

For a vulcanized tire, a plurality of product inspections on uniformity, dynamic balance and the like are performed by using an inspection apparatus.

Since a tire is manufactured by stacking a plurality of members, the air or foreign matters may remain between the respective layers. The tire in which the air or foreign matters remain should be discarded as a defective product. Therefore, in recent years, a tire internal defect is detected in a non-destructive manner by using a non-destructive inspection apparatus (for example, refer to JP-A-2018-77192).

### SUMMARY OF THE INVENTION

However, in order to add the above-mentioned inspection apparatus configured to detect the tire internal defect in a non-destructive manner to an already-existing inspection apparatus configured to inspect the uniformity and the dynamic balance, a large-scale reconstruction is required.

It is therefore an object of the present invention to provide a tire inspection apparatus configured to detect a tire internal defect in a non-destructive manner and capable of being easily introduced to an already-existing tire inspection apparatus.

A tire inspection apparatus of the present invention includes a conveyor configured to convey a vulcanized tire, a centering device configured to position the tire conveyed by the conveyor to a predetermined position, an inspection part provided on a side of the conveyor and configured to inspect an internal defect of the tire, and a conveying device configured to convey the tire positioned by the centering device to the inspection part with holding the tire, wherein the conveying device includes a rotation means for rotating the tire around an axis of the tire with holding the tire, and wherein the inspection part is configured to inspect an internal defect of the tire held by the conveying device.

According to the present invention, it is possible to easily add the inspection apparatus configured to detect the tire internal defect in a non-destructive manner to an already-existing tire inspection apparatus.

### BRIEF DESCRIPTION OF THE DRAWINGS

FIG. 1 is a schematic plan view of a tire inspection apparatus in accordance with an exemplary embodiment of the present invention.

FIG. 2 is a side view of the tire inspection apparatus in accordance with the exemplary embodiment of the present invention.

FIG. 3 is an enlarged view of main parts of FIG. 2.

FIG. 4 is a block diagram depicting a control configuration of the tire inspection apparatus.

### DETAILED DESCRIPTION OF THE INVENTION

Hereinbelow, an exemplary embodiment of the present invention will be described with reference to the drawings.

A tire inspection apparatus 50 of the exemplary embodiment is added to an already-existing inspection apparatus 1 including a first inspection part 2 and a second inspection part 3, and is configured to inspect an internal defect of a vulcanized tire (hereinbelow, also simply referred to as tire) T.

The already-existing inspection apparatus 1 includes the first inspection part 2 provided between a conveyor 4 and a conveyor 5, and the second inspection part 3 provided between the conveyor 5 and a conveyor 6.

The first inspection part 2 includes a spindle shaft 7, a rotary drum mechanism 8, and a first load measurement unit 10, and the tire T placed on the conveyor 4 is conveyed by a conveying means (not shown). The first inspection part 2 is configured to hold the tire T conveyed from the conveyor 4 by rims provided to the spindle shaft 7, to rotate the tire at predetermined speed while bringing the tire into contact with an outer peripheral surface of a drum part 9 of the rotary drum mechanism 8, and to measure a force component transmitted to a shaft part of the drum part 9 by the first load measurement unit 10, thereby measuring uniformity of the tire T attached to the spindle shaft 7. When the measurement of the uniformity in the first inspection part 2 is over, the tire T held by the spindle shaft 7 is transferred to the conveyor 5 by a conveying means (not shown).

The second inspection part 3 includes a spindle shaft 16, and a second load measurement unit 17, and the tire T placed on the conveyor 5 is conveyed by a conveying means (not shown). The second inspection part 3 is configured to rotate the tire T conveyed from the conveyor 5 by the spindle shaft 16 at higher speed than upon the measurement of the uniformity, in a state in which the drum part and the like are not in contact with the tire. A force component in a radial direction of the tire generated in the spindle shaft 16 is measured by the second load measurement unit 17 at that time, so that dynamic balance of the tire T is measured. When the measurement of the dynamic balance in the second inspection part 3 is over, the tire T held by the spindle shaft 16 is transferred to the conveyor 6 by a conveying means (not shown).

The tire inspection apparatus 50 includes a centering device 52 configured to position the tire T, which is to be conveyed by the conveyor 5 configured to interconnect the first inspection part 2 and the second inspection part 3, to a predetermined position, an inspection part 54 and a discharge conveyor 55 provided in parallel to the conveyor 5 on a side of the conveyor 5 (a direction perpendicular to a conveying direction of the tire T by the conveyor 5), a conveying device 56 configured to hold the tire T positioned by the centering device 52 and to convey the tire to the inspection part 54 and the discharge conveyor 55, a return conveyor 11 configured to interconnect the inspection part 54 and the conveyor 5, and a control unit 12 configured to control the above elements.

The centering device 52 includes a lifting table 58 provided between a plurality of rollers configuring the conveyor 5, and a pair of pressing pieces 60 configured to press an outer surface (so-called, a tread surface) of the tire T from positions facing each other. The lifting table 58 is provided on its upper surface with multidirectional rollers 58a for assisting movement of the tire T in any direction in a horizontal plane. The lifting table 58 is configured to vertically move by a drive means (not shown), so that the multidirectional rollers 58a are moved between positions below and above the rollers of the conveyor 5.

In the centering device 52, in a state in which the multidirectional rollers 58a are arranged below the rollers of the conveyor 5, when the tire T placed on the conveyor 5 is conveyed above the lifting table 58, the lifting table 58 is moved upward so that the multidirectional rollers 58a are to be located above upper surfaces of the rollers of the conveyor 5. Thereby, the tire T supported on the conveyor 5 is supported on the multidirectional rollers 58a of the lifting table 58. Then, the centering device 52 presses so that the pair of pressing pieces 60 are to sandwich the outer surface of the tire T supported on the multidirectional rollers 58a, thereby positioning the tire T to a predetermined position on the upper surface of the lifting table 58.

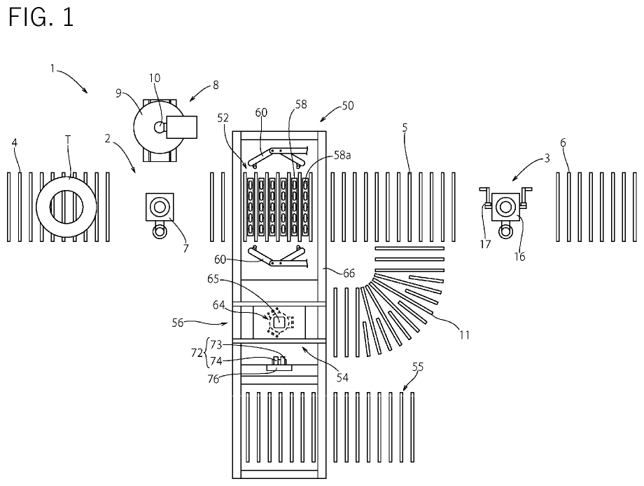

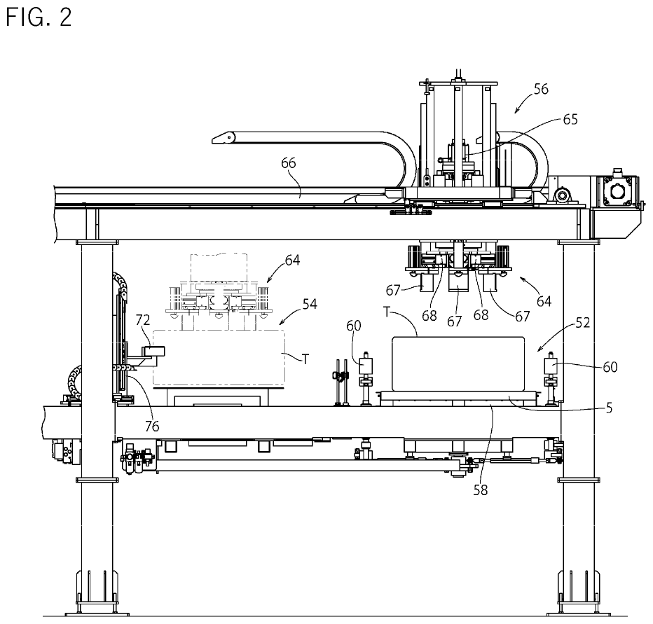

As shown in FIGS. 1 to 3, the conveying device 56 includes a chuck part 64 configured to hold the tire T, a chuck driving means 65 for rotating the chuck part 64 around an axis of rotation of the tire T and vertically moving the same, and a linear guide 66 configured to move the chuck part 64 and the chuck driving means 65 to a side of the conveyor 5.

The chuck part 64 includes a plurality of (three, in the present example) gripping portions 67 configured to hold the tire T with being in contact with an inner peripheral part (bead part) of the tire, an air actuator 68 configured to move the plurality of gripping portions 67 in the radial direction of the tire, and a non-contact displacement meter 69 configured to detect positions of the plurality of gripping portions 67.

When the tire T is positioned on the lifting table 58 of the centering device 52 by the pair of pressing pieces 60, the chuck part 64 inserts the plurality of gripping portions 67 into a hollow part of the tire T from above. The chuck part 64 is configured to hold the tire T by moving the plurality of gripping portions 67 outward in the radial direction of the tire to positions in which they are to contact the inner peripheral part of the tire, in a synchronization manner.

At this time, the pair of pressing pieces 60 preferably press the outer surface of the tire T inward in the radial direction to hold and fix the tire T until the chuck part 64 holds the tire T by the plurality of gripping portions 67.

In this way, the tire T is sandwiched and held by the pair of pressing pieces 60 until the chuck part 64 holds the inner peripheral part of the tire T, so that the tire T positioned by the pair of pressing pieces 60 is transmitted to the chuck part 64 without deviation.

Also, an air pressure, which is introduced to the air actuator 68 when moving the gripping portions 67 outward in the radial direction of the tire after inserting the plurality of gripping portions 67 into the hollow part of the tire T, may be changed depending on the positions of the gripping portions 67 detected by the non-contact displacement meter 69. That is, preferably, the air of a first pressure P1 is introduced into the air actuator 68 to move the gripping portions 67 after the movement of the gripping portions 67 starts until an interval between the gripping portions 67 and the inner peripheral part of the tire T comes close to a predetermined length, and when the interval between the gripping portions 67 and the inner peripheral part of the tire T becomes equal to or smaller than a predetermined length, the air of a second pressure P2 lower than the first pressure P1 is introduced into the actuator 68 to bring the gripping portions 67 into contact with the inner peripheral part of the tire T.

In this way, the pressure of the air to be introduced into the actuator 68 is controlled, so that it is possible to reduce a shock upon collision of the gripping portions 67 with the inner peripheral part of the tire T, thereby suppressing a damage and deformation of the tire T.

When the chuck part 64 holds the tire T, the conveying device 56 moves up the chuck part 64 by the chuck driving means 65, moves the chuck part 64 above the inspection part 54 by the linear guide 66, and then moves down the chuck part 64 to arrange the tire T in the inspection part 54. Also, the conveying device 56 is configured to transfer the tire T held by the chuck part 64 to the discharge conveyor 55 and to discharge the tire T from the tire inspection apparatus 50, as required.

The inspection part 54 includes a transmitting and receiving antenna unit 72, and an antenna moving means 76, and is configured to inspect an internal defect of the tire T held by the chuck part 64 in a non-destructive manner, in cooperation with the conveying device 56.

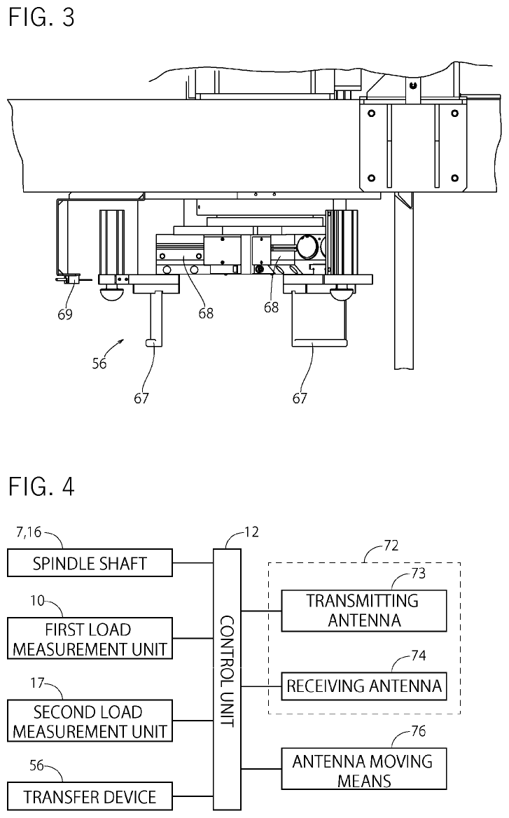

The transmitting and receiving antenna unit 72 includes a transmitting antenna 73 configured to output a microwave to be irradiated to the tire T, and a receiving antenna 74 spatially separated from the transmitting antenna 73 and configured to receive a reflected wave of the microwave from the tire T (refer to FIGS. 1 and 3).

The microwave to be irradiated from the transmitting antenna 73 to a to-be-measured object includes a frequency of causing interference by multiple reflection between a surface of the to-be-measured object and a defect. When an intensity of the reflected wave at the frequency is measured at the receiving antenna 74, an internal defect of the to-be-measured object can be detected. In the meantime, the frequency of the microwave can be selected in a band ranging from 300 MHz to 300 GHz. Also, an irradiation range of the microwave by the transmitting antenna 73 is not particularly limited, and a defect can be detected in a range of about 30 mm², in the present example.

The transmitting antenna 73 and the receiving antenna 74 are connected to the control unit 12 configured to control the entire tire inspection apparatus 1, and generation of a wave source of the microwave to be output from the transmitting antenna 73 and generation of a detection signal from the reflected wave received at the receiving antenna 74 are performed in the control unit 12.

In the meantime, the specific configuration for executing generation of a wave source of the microwave and generation of a detection signal is not particularly limited. For example, the control unit 12 includes a fixed oscillator, a sweep oscillator (local oscillator), a mixer, a frequency filter, an IQ mixer and the like. The control unit 12 is configured to generate a transmission wave by multiplexing a signal of a sweep frequency generated by the sweep oscillator to a signal generated by the fixed oscillator configured to transmit a microwave of a fixed frequency, and to output the transmission wave from the transmitting antenna 73. A receiving circuit is configured in a heterodyne manner. The receiving circuit is configured to transmit a localized wave, which is a microwave of a frequency different from the frequency of the microwave output from the transmitting antenna 73, by using the sweep oscillator as a local oscillator, to multiplex the localized wave and the received signal received at the receiving antenna 74 in the mixer, to generate a difference frequency signal having a difference frequency of both the frequencies, and to cause the same to pass through the frequency filter, thereby obtaining only a difference frequency signal. This signal is input to the IQ mixer, as a measurement signal, which is then multiplexed with a reference wave signal of the frequency of the fixed oscillator in the IQ mixer and a detection signal is thus obtained.

The antenna moving means 76 is configured to move the transmitting and receiving antenna unit 72 in the width direction of the tire (vertical direction), and to irradiate the microwave over an entire width of the tire T held by the chuck part 64 of the inspection part 54.

The inspection part 54 is configured to output the microwave by the transmitting antenna 73 and to receive the reflected wave by the receiving antenna 74 while rotating the tire T held in the chuck part 64 by the chuck driving means 65. The output of the microwave and the reception of the reflected wave are performed until the measurement over an entire width of a tread part of the tire T is completed while moving the transmitting and receiving antenna unit 72 with a predetermined interval in the width direction of the tire by using the antenna moving means 76 whenever the tire T rotates one revolution.

Meanwhile, in the exemplary embodiment, the tire T is inspected by one transmitting and receiving antenna unit 72. However, the two transmitting and receiving antenna units 72 maybe provided with an interval in the width direction of the tire T. In this case, the antenna moving means 76 may inspect the tire T by moving the transmitting and receiving antenna units 72 in the width direction of the tire T by at least a half-length of the entire width of the tread part.

The control unit 12 is configured by a computer including a calculation processing unit, a memory, and a display. As shown in FIG. 4, the control unit 12 is connected to the spindle shafts 7 and 16, the first load measurement unit 10, the second load measurement unit 17, the conveying device 56, the transmitting and receiving antenna unit 72, and the antenna moving means 76, and is configured to control operations thereof. Also, the control unit 12 is configured to calculate the uniformity from the measurement result input from the first load measurement unit 10, to calculate the dynamic balance from the measurement result input from the second load measurement unit 17, and to detect whether there is an internal defect in the tire T from the measurement result input from the receiving antenna 74.

Subsequently, operations of the tire inspection apparatus 50 are described.

When the tire T of which the uniformity has been measured in the first inspection part 2 is transferred to the conveyor 5 by the conveying means (not shown), the centering device 52 positions the tire T to a predetermined position on the upper surface of the lifting table 58.

The positioned tire T is held by the chuck part 64 of the conveying device 56 and is conveyed to the inspection part 54.

In the inspection part 54, while rotating the tire T held by the chuck part 64, the output of the microwave by the transmitting antenna 73 and the reception of the reflected wave by the receiving antenna 74 are performed. Whenever the tire T rotates one revolution, the transmitting and receiving antenna unit 72 is moved with a predetermined interval in the width direction of the tire, so that it is detected whether there is an internal defect in the tire T.

When the internal defect of the tire T is detected by the inspection part 54, the conveying device 56 transfers the tire T held by the chuck part 64 to the discharge conveyor 55, and discharges the tire T to an outside of the tire inspection apparatus 50 and the inspection apparatus 1.

On the other hand, when the internal defect of the tire T is not detected by the inspection part 54, the conveying device 56 transfers the tire T held by the chuck part 64 to the return conveyor 11 via a transfer device (not shown). The tire T transferred to the return conveyor 11 is returned to the conveyor 5, is then conveyed to the second inspection part 3 by the conveying means (not shown) and is subjected to measurement of the dynamic balance.

When the measurement of the dynamic balance is over, the tire T held by the spindle shaft 16 is transferred to the conveyor 6 by the conveying means (not shown), and the tire T is taken out from the inspection apparatus 1, so that all the inspections are over.

According to the tire inspection apparatus 50 of the exemplary embodiment as described above, the inspection part 54 is provided on a side of the conveyor 5 configured to convey the tire T, and the tire T is conveyed from the conveyor 5 to the inspection part 54 by the conveying device 56 for inspection of a tire internal defect. For this reason, it is possible to easily add the tire inspection apparatus 50 to the already-existing inspection apparatus 1 without providing the tire inspection apparatus 50 so as to be interposed on the way of the already-existing inspection apparatus 1.

Also, in the exemplary embodiment, after the chuck part 64 conveys the tire T from the conveyor 5 to the inspection part 54 with holding the tire T on the conveyor 5, the tire T is rotated with being held for inspection of the internal defect of the tire T. Therefore, it is not necessary to give and take the tire T in the inspection part 54, so that it is possible to shorten the inspection time.

Also, in the exemplary embodiment, before the tire T is conveyed from the conveyor 5 to the inspection part 54 by the conveying device 56, the tire T on the conveyor 5 is positioned by the centering device 52 and then the tire T is held by the chuck part 64 of the conveying device 56. Therefore, the position in which the tire T is held by the chuck part 64 is constant. For this reason, during the inspection, it is possible to arrange the tire T in a predetermined position and to make a distance from the transmitting and receiving antenna unit 72 to the tire surface constant, so that it is possible to detect the defect with accuracy. In particular, like the exemplary embodiment, the pair of pressing pieces 60 press the outer surface of the tire T each other inward in the radial direction and hold and fix the tire T until the chuck part 64 holds the tire T. Therefore, the tire T is not moved on the lifting table 58 until the chuck part 64 holds the tire T.

Also, in the exemplary embodiment, the tire T of which an internal defect is not detected in the inspection part 54 is returned to the already-existing inspection apparatus 1 for resuming subsequent inspection (measurement of the dynamic balance). When the internal defect is detected in the inspection part 54, the tire T is not returned to the conveyor 5 but is transferred to the discharge conveyor 55 and is discharged to the outside of the inspection apparatus. Therefore, the tire T of which an internal defect is detected, which cannot be corrected and is thus discarded, is not subjected to additional inspection, so that the inspection efficiency of the inspection apparatus 1 is improved.

Although the exemplary embodiments have been described, the exemplary embodiments are just exemplary and are not intended to limit the scope of the invention. The novel exemplary embodiments can be implemented in other various forms, and can be diversely omitted, replaced and changed without departing from the gist of the invention.

What is claimed is:

1. A tire inspection apparatus comprising:
a conveyor configured to convey a vulcanized tire;
a centering device configured to position the tire conveyed by the conveyor to a predetermined position;
an inspection part provided on a side of the conveyor and configured to inspect an internal defect of the tire; and
a conveying device configured to convey the tire positioned by the centering device to the inspection part with holding the tire,
wherein the conveying device comprises a rotation means for rotating the tire around an axis of the tire with holding the tire, and
wherein the inspection part is configured to inspect an internal defect of the tire held by the conveying device.

2. The tire inspection apparatus according to claim 1,
wherein the centering device comprises a pressing piece configured to press an outer surface of the tire,
wherein the conveying device comprises a chuck part configured to hold an inner peripheral part of the tire, and
wherein in a state in which the pressing piece presses the outer surface of the tire, after the chuck part holds the inner peripheral part of the tire, the pressing piece releases the pressing of the tire.

3. The tire inspection apparatus according to claim 2,
wherein the chuck part comprises a plurality of gripping portions configured to contact the inner peripheral part of the tire, an air actuator configured to move the plurality of gripping portions in a radial direction of the tire, and a non-contact displacement meter configured to detect positions of the gripping portions, and
wherein when an interval between the gripping portions and the inner peripheral part of the tire becomes equal to or smaller than a predetermined length, a pressure of air to be introduced into the air actuator is lowered.

4. The tire inspection apparatus according to claim 1,
wherein the conveying device is configured to return the tire of which an internal defect is not detected in the inspection part to the conveyor.

5. The tire inspection apparatus according to claim 1,
wherein the conveying device is configured to take out the tire of which an internal defect is detected in the inspection part to a place except the inspection part and the conveyor.

6. The tire inspection apparatus according to claim 2,
wherein the conveying device is configured to return the tire of which an internal defect is not detected in the inspection part to the conveyor.

7. The tire inspection apparatus according to claim 3,
wherein the conveying device is configured to return the tire of which an internal defect is not detected in the inspection part to the conveyor.

8. The tire inspection apparatus according to claim 2,
wherein the conveying device is configured to take out the tire of which an internal defect is detected in the inspection part to a place except the inspection part and the conveyor.

9. The tire inspection apparatus according to claim 3,
wherein the conveying device is configured to take out the tire of which an internal defect is detected in the inspection part to a place except the inspection part and the conveyor.

10. The tire inspection apparatus according to claim 4,
wherein the conveying device is configured to take out the tire of which an internal defect is detected in the inspection part to a place except the inspection part and the conveyor.
